(19) United States
(12) Patent Application Publication
(10) Pub. No.: US 2005/0030163 A1
(43) Pub. Date: Feb. 10, 2005

(54) Medicine dispenser and method

(76) Inventors: Robert Shiner, Kfar Azar (IL); Ben-Zion Rubinfeld, Kfar Azar (IL)

Correspondence Address: Kenneth I Kohn;Kohn & Associates, Suite 410, 30500 Northwestern Hwy, Farmington Hills, MI, 48334, US

(21) Appl. No.: 10/485,503

(22) PCT Filed: Jul. 30, 2002
(86) PCT No.: PCT/US02/23997

Related U.S. Application Data
(60) Provisional application No. 60/308,873, filed on Jul. 30, 2001.

(51) Int. Cl. G08B 1/00

(52) U.S. Cl. 340/309.16

(57) ABSTRACT

A dispensing device (10) for dispensing medication includes a habitually used mechanism (12) for being used habitually by a patient and a medication dispensing mechanism (14) for dispensing medication at the times of the use of the habitually used device.

### CROSS-REFERENCE TO RELATED APPLICATIONS

This application claims priority to U.S. Ser. No. 60/308,873, filed Jul. 30, 2001, which is incorporated herein by reference.

### TECHNICAL FIELD

The present invention relates to devices and methods for dispensing medication and more specifically relates to mechanisms for reminding patients to take medication in combination with a medication dispenser.

### BACKGROUND OF THE INVENTION

Medical treatment that requires regular ongoing administration of medicaments is plagued by poor compliance. For example, asthma affects up to thirty percent (30%) of the world population (GINA workshop report 1995) although the prevalence of the disease is variable in different societies. The currently accepted guidelines for the management of asthma recommend prophylactic (preventative) treatment in all but the mildest of cases. Most of these types of treatment must be taken at least twice daily, usually by an inhaler. Such treatment may also include administering tablets or other types of medication. However, compliance with such treatment regimens can be difficult, especially for older patients or patients suffering from cognitive diseases.

Various alarm mechanisms are used by patients to remind them to take their medication. Such simple alarms are physically dissociated from the medication. People can hear or see the alarm and not remember what it relates to or forget to take the medication in between seeing the alarm and finding the medication. Hence, there are practical problems associated with the physical separation of the alarm from the medication. The problem can be as simple as the patient forgetting to carry the alarm with them.

Accordingly, it would be beneficial to combine a medication dispenser with some means for reminding a patient to take the medication treatment wherein the alarm is not forgotten.

### SUMMARY OF THE INVENTION

In accordance with the present invention, there is provided a medication dispensing device including a habitually used mechanism for being used habitually by a patient and a medication dispensing device for dispensing medication at the time of use of the habitually used mechanism. Accordingly, the patient would be reminded of taking the medication at each time the habitually used mechanism is used.

The present invention further provides a method of dispensing the medication by the steps of dispensing medication from the device, which also dispenses a habitually used device to remind the user to take the medication while using the habitually used device.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 shows a perspective view of the first embodiment of the present invention;

FIG. 2 shows a perspective view of the invention with components removed;

FIG. 3 shows a top view of the present invention;

FIG. 4 shows a cross-sectional view of the present invention taken substantially along lines A-A of FIG. 3;

FIG. 5 shows a perspective view of a second embodiment of the present invention; and

FIG. 6 shows a perspective view of the second embodiment containing a toothbrush and an inhaler.

### DETAILED DESCRIPTION OF THE INVENTION

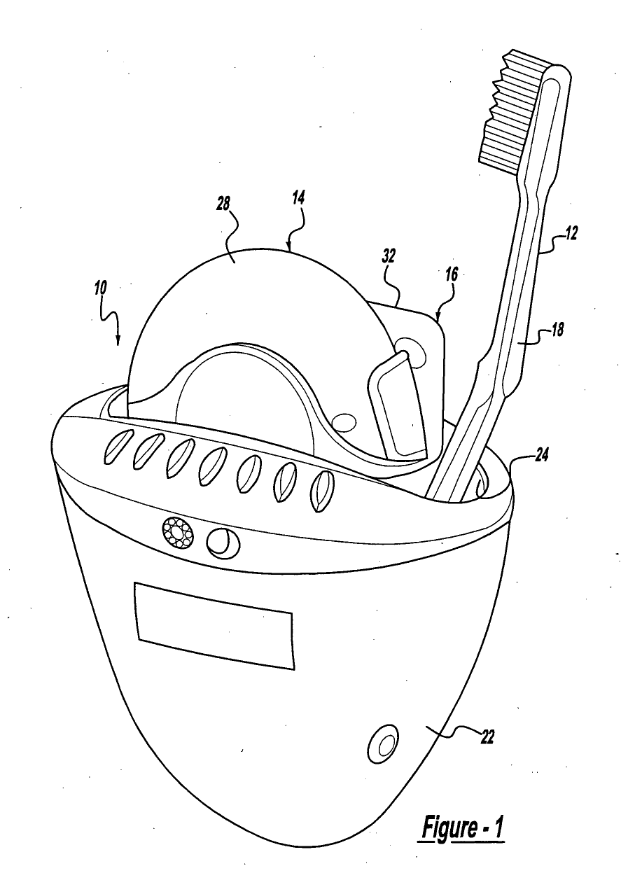

Generally, the present invention provides a medication dispensing device, generally shown at 10 in FIGS. 1-4, for assisting patients to self-dispense medication at appropriate described times. The device 10 includes a habitually used mechanism or component 12 for being habitually used by a patient and at least one medication dispensing device, generally indicated at 14 and 16 in FIG. 1, for dispensing medication at the times of use of the habitually used mechanism. That is, the single assembly includes a device regularly or habitually used by a patient such that when the patient utilizes the habitually used device, the patient is in proximity of and can be reminded of using the medication dispensing device or devices 14, 16. Since it is recognized that patients having memory lapse problems still habitually perform certain activities engrained in the regular course of events of their day, if medication is appropriately dispensed at those times, the patient can utilize the present invention to be reminded of and use medication at the appropriate times.

As shown in FIG. 1, the habitually used mechanism is a toothbrush 12, including a handle portion 18 and a bristle or head portion 20. The device 10 includes a body portion 22, including a pocket or recess portion 24 in which the handle portion 18 of the toothbrush 12 can be disposed. The habitually used mechanism can take many other forms, such as a vitamin dispenser, soap dispenser, car key holder, silverware dispenser, remote control holder, and sugar dispenser, as well as many other forms. What is critical is that the habitually used mechanism is one that is regularly used by a patient in what would be a habitual manner. For example, people habitually brush their teeth at least twice a day, sometimes three times or more at set times. Examples of other habitual uses are taking vitamins, washing one's face with soap, taking one's keys in the morning, using silverware, such as a cereal spoon every morning, dispensing a remote control holder for a television that one may watch two or three or more times a day in a regular pattern, or even a sugar dispenser or the like which one would use each morning and evening with food. In other words, the habitually used device or mechanism relates to a regularly or periodically used device that a patient may use the same set times every day.

The patient need not be an elderly or infirm patient. Children brush their teeth at least twice a day at set times, which can correlate to the times for medicating the child. Such a habitual use will always bring a patient, even one with diminished capacity, to the same venue or reference point in a day in a reliably periodic and consistent manner.

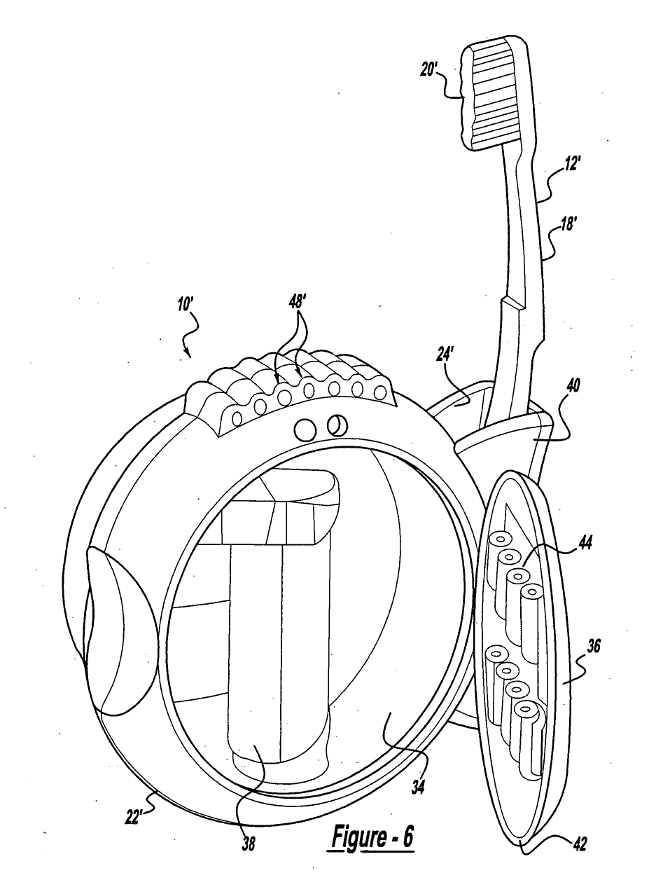

The medication dispensing mechanism of the present invention includes a pocket or storage area for containing or holding the medication dispensing device. For example, the device 10 shown in FIGS. 1-4, includes the body portion 22, which can include a pocket or cavity 26 for containing a medication dispensing device, such as an inhaler 28 as shown in FIG. 1. The body portion 22 can include a second pocket 30 for containing a second dispensing device such as a pill dispenser 32. Of course, various configurations of pockets can be utilized for the body portion 22 to contain various types or amounts of medication dispensing devices. For example, a second embodiment of the invention, as shown in FIGS. 5 and 6, wherein prime numbers are used to indicate like components between the various embodiments, includes an inner chamber 34 and a door member 36 for opening and closing to expose the inner chamber 34. An inhaler 38 is shown contained within the inner chamber 34.

More generally, the medication dispensing device can be any sort of device, which provides medication to a patient. Such devices can include but are not limited to inhalers, pill bottles, spray bottles, injectors, heaters, inoculators, or other means used in the art. If the medication is to be dispensed at the same time as the habitual use, then the patient can be reminded of the same, thereby increasing the effectiveness of compliance.

The device 10 can take on various configurations. For example, FIGS. 1-4 show the device 10 in a pebble design. The body portion 22 includes openings in the top thereof for containing the habitually used device 12 and the medication dispensing devices 28, 32. Alternatively, as shown in FIGS. 5 and 6, the device 10′ is shown in a goldfish configuration wherein a tail portion 40 of the goldfish design includes the pocket 24′ for containing the toothbrush 12′ therein. The goldfish configuration of the device 10′ also includes the door or hatch 36 for opening and closing to expose the inner compartment 34. The inner surface 32 of the door 36 is shown to include pill containers 44 to allow for dispensing therefrom. Again, many modifications of the device can be accomplished to combine for the dispensing of various types of medication.

The device can include a date indicating mechanism 48, 48′ for indicating the date of use of the habitually used mechanism. The date indicating mechanism 48, 48′ can be in the form of labeled LED lights as shown in the figures, for reminding the patient of the date of use. Additional indicator lights 50, 52 can be disposed on the device to provide indication to the patient as to whether or not medication had been administered on that date. One light 50 can be green and a second light 52 can be red, the green light indicating that medication is to be taken and the red light indicating that the medication has already been administered. Alternatively, the lights can indicate a sun or moon, reminding the patient of daytime or nighttime administration. Of course, these warning lights can take various other forms.

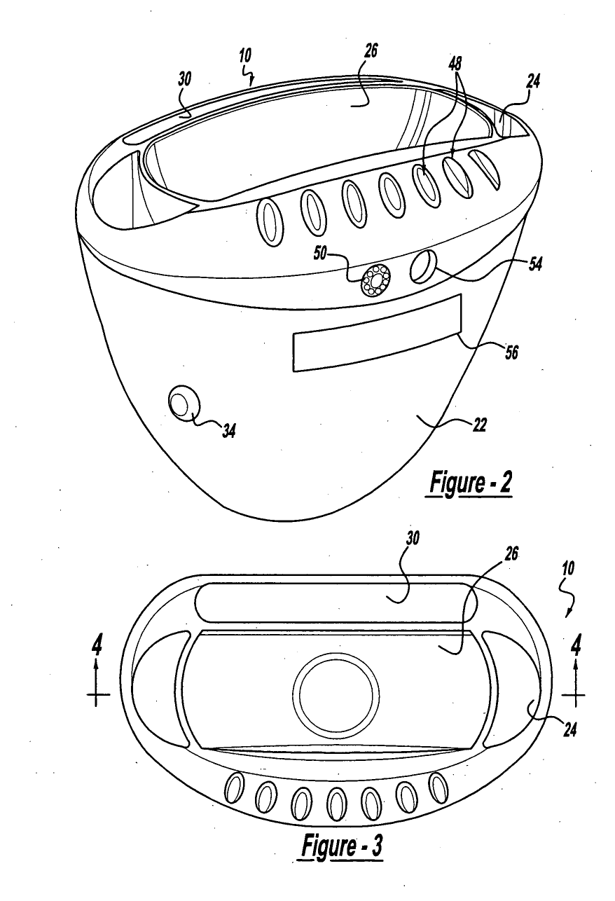

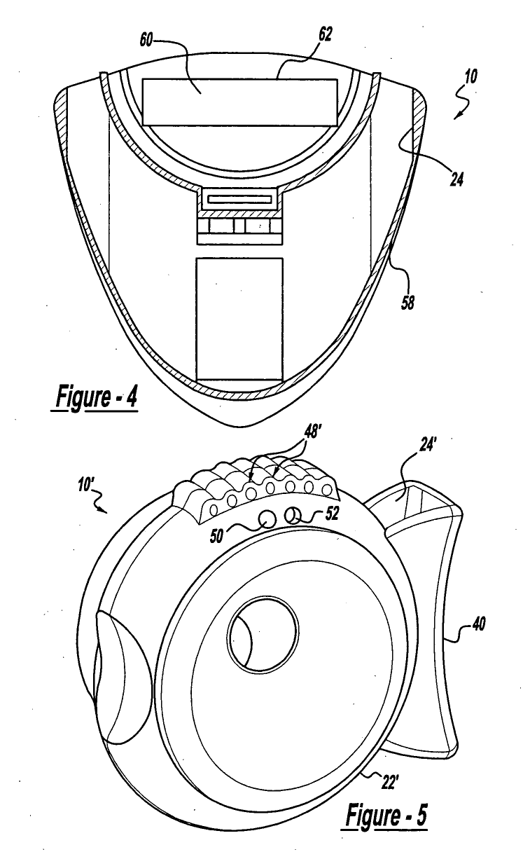

Additionally, as shown in FIG. 2, the device can include a small speaker mechanism 54 and/or visual indicating mechanism 56, which can audibly or visually, respectively, remind the patient to take the medication after utilizing the habitually used device. Sensors can be used, which are well-known in the art, to trigger an audible or visual message to be disseminated from the device upon the patient removing the habitual used device from the dispensing device 10. By way of specific example, the pocket 24, as shown in FIG. 4, can include a sensor 58 of the type well-known in the art. The sensor can be triggered when the toothbrush 12 is removed from the pocket. The sensor can be operatively connected through software or other electronic control and relay 60, shown in FIG. 4, disposed on a printed board 62, which would then trigger either a visual indicator 56 or an audible indicator 54 to provide either a written message in the visual indicator 56 or provide an audible message through the speaker 54 to remind the patient to take the medication. In this manner, the habitually used device and medication dispenser are not only before the patient at the same venue, but also the use of the habitual device will trigger a reminder to the patient to actually dispense the medication at the appropriate time. The software can be programmed in combination with a timing mechanism to note that a single use of the habitually used device at a certain time period will trigger the reminder to use the medication, whereas multiple uses of the device at the wrong time will not trigger the reminder. The device 10 can include further a locking mechanism to only allow access to the medication at the appropriate time upon the first use of the habitually used device, while not allowing the removal of the medication device at other times. Such timing devices are well known in the art for other uses.

The device 10, 10′ can be further connected, by means known in the art, through the software 60 to an online monitoring location. More specifically, the present invention can include software known in the art, which tracks the use of the device, and such tracking information can be then sent online to a monitoring center. Improper use of the device can trigger an alarm through sensors on the medication dispenser or the habitual use dispenser, or both, such that a caretaker can be informed of inappropriate use of the device.

In operation, a patient who habitually brushes their teeth twice a day and requires medication at those same time increments would habitually utilize the toothbrush 12, 12′. Upon removing the toothbrush 12, 12′ an alarm can be triggered either visually by the visual indicator 56 or audibly by the audible indicator 54 to remind the patient that it is also time to utilize the medication. The device would allow access to the medication, by either unlocking the inhaler and pill containers 28, 32 from the device shown in FIG. 1, or by unlocking the door 36 in the device shown in FIGS. 5 and 6. Such locking devices are not always critical and are not required for use of the present invention. However, such locking mechanisms do provide for the utility for the present invention for situations where critical monitoring of medication is required. The patient would then utilize the medication, then return the device for dispensing the medication to the device 10, 10′. Light indicators 50 and 52 would indicate that the medication has been dispensed. Online monitoring then can be assured that the patient has at least removed the medication dispensing device from the body portion 22, 22′ for use. Should the medication dispensing device not be removed, an alarm would sound at the monitoring location and a caregiver would be informed of such. Accordingly, the present invention provides a method of dispensing a medication by the steps of dispensing medication from a device, which also dispenses a habitual used device to remind a user to dispense and use medication while using the habitually used device.

The invention has been described in an illustrative manner, and it is to be understood that the terminology, which has been used, is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

1. A medication dispensing device including habitual use means for being used habitually by a patient and
medication dispensing means for dispensing medication at the times of use of the said habitual use means.

2. The device of claim 1, wherein said habitual use means is selected from the group consisting of a toothbrush dispenser, vitamin dispenser, soap dispenser, car key holder, silverware dispenser, remote control holder, and sugar dispenser.

3. A device of claim 2, including a base, said habitual use means including at least one pocket portion in said base for containing a habitually used object.

4. The device of claim 1, wherein said medication dispensing means is selected from the group consisting of inhalers, pill bottles, spray bottles, injectors, heaters, and inoculators.

5. The device of claim 1, including date indicating means for indicating the date of use of said habitual use means and said medication dispensing means to insure dispensing of said medication dispensing means.

6. The device of claim 4, including software operatively connected to said date indicating means for tracking use of said medication dispensing means.

7. A device of claim 6, wherein said medication dispensing means includes a dispenser device removable from a pocket portion of a body of said device, said date indicator means including sensor means for sensing removal of said dispenser device from said pocket portion, thereby indicating use of said medication dispensing means.

8. A device of claim 7, including online communication means operatively interconnecting said software to an offsite monitor for offsite monitoring of use of said medication dispensing means.

9. A device of claim 1, including audible reminder means for providing verbal reminders to the patient to use the medication after using said habitual use means.

10. A device of claim 9, wherein said audible reminder means includes sensor means for sensing use of said habitual use means and triggering an audible message to disseminate from said device reminding the patient to also use said medication dispensing means.

11. A device of claim 1, including visual reminder means for providing a visual reminder to the patient to use the medication after using said habitual use means.

12. A device of claim 11, wherein said visual reminder means includes sensor means for sensing use of said habitual use means and triggering a visual message to disseminate from said device reminding the patient to also use said medication dispensing means.

13. A method of dispensing a medication by steps of dispensing medication from a device that also dispenses a habitually used device to remind a user to dispense and use medication while using the habitually used device.
